(19) United States
(12) Patent Application Publication
(10) Pub. No.: US 2021/0207492 A1
(43) Pub. Date: Jul. 8, 2021

(54) INDUSTRIAL GAS TURBINE ENGINE WITH FIRST AND SECOND STAGE ROTOR COOLING

(71) Applicant: Florida Turbine Technologies, Inc., Jupiter, FL (US)

(72) Inventors: Russel B. JONES, North Palm Beach, FL (US); Wesley D. BROWN, Jupiter, FL (US)

(21) Appl. No.: 15/998,911

(22) PCT Filed: Feb. 14, 2017
(86) PCT No.: PCT/US2017/017820

§ 371 Date: Aug. 16, 2018

Related U.S. Application Data
(60) Provisional application No. 62/296,364, filed on Feb. 17, 2016.
(60) Provisional application No. 62/296,251, filed on Feb. 17, 2016.
(60) Provisional application No. 62/296,249, filed on Feb. 17, 2016.
(60) Provisional application No. 62/295,633, filed on Feb. 16, 2016.
(60) Provisional application No. 62/295,597, filed on Feb. 16, 2016.
(60) Provisional application No. 62/295,765, filed on Feb. 16, 2016.

(51) Int. Cl. F01D 25/12; F02C 7/18

(52) U.S. Cl. CPC F01D 25/12; F01D 5/081; F02C 7/18

(57) ABSTRACT

An industrial gas turbine engine with first and stage turbine rotor blade cooling circuit in which the blade cooling air flows through a central passage within the rotor of the engine, flows through a space between first and second stage rotors, separates into two flows with one flow going to the first stage blades and the second flow going to the second stage blades, the two flows then collecting in a common manifold, where the spent blade cooling air flows forward through the first stage rotor and along a rotor cooling passage and into a stator cavity, where the cooling air then is discharged into a combustor.

### GOVERNMENT LICENSE RIGHTS

This invention was made with Government support under contract number DE-FE0023975 awarded by Department of Energy. The Government has certain rights in the invention.

### TECHNICAL FIELD

The present invention relates generally to a gas turbine engine, and more specifically to a large frame heavy duty industrial gas turbine engine with a semi-closed loop rotor disk cooling circuit that delivers spent cooling air to the combustor.

### BACKGROUND

In an industrial gas turbine engine, an electric generator is driven by a rotor of the gas turbine engine to produce electrical power. To improve efficiency, the rotor of the engine is directly connected to the generator without a gear box. For a 60 Hertz power grid, the engine and the generator will operate at 3,600 rpm. For a 50 hertz power grid typical of European countries, the engine and the generator will operate at 3,000 rpm.

The efficiency of the engine can also be increased by using a higher firing temperature. However, the turbine inlet temperature is limited to the material properties of the parts exposed to the hot gas stream and to an amount of cooling provided to these hot parts. The first stage of the turbine receives the most amount of cooling air because these parts are exposed to the highest temperatures. The second stage of the turbine also requires cooling, but a smaller amount than the first stage. The cooling air for the first and second stage airfoils is typically discharged into the hot gas stream through film cooling holes or exit slots to provide film cooling of an external surface of the airfoils. Thus, the work done to compress the cooling air that is discharged into the hot gas flow through the turbine is lost.

### SUMMARY

An industrial gas turbine engine with first and second stage rotor blade cooling, where over-pressurized cooling air is supplied to both stages of rotor blades through a central passage within a rotor of the engine to limit heating of the cooling air. The over-pressurized cooling air is then split up between the first and second stage rotors into a first stage blade cooling passage and a second stage blade cooling passage and delivered into internal cooling air circuits within each of the first and second stages.

Spent cooling air from the first and second stages of rotor blades is then discharged into a common collection manifold positioned between the first and second stage rotors. The spent cooling air within the collection manifold is then passed through the first stage rotor and into a turn-down manifold where the cooling air is then passed through the rotor and into a stator cavity. The spent cooling air from the stator cavity is then passed through stator passages and into a combustor for reuse.

A spacer disk is used between the first and second stage rotors to split up the supply of over-pressurized air from the central passage into a first stage rotor cooling passage and a second stage rotor cooling passage. Each of the first and second stage cooling passages is connected to the respective rotor disk using hollow air supply tubes that form seals between the spacer disk and the respective rotor. Hollow air exhaust tubes form a sealed passage from the respective rotor disk into the collection manifold.

Axial cross-over tubes form a sealed passage for hot cooling air through the first stage rotor and into a turn-down manifold located on a forward side of the first stage rotor. An exhaust transfer tube oriented in a radial inward direction forms a sealed passage between the turn-down tube and a passage within the rotor for the hot air flow. The transfer tube has a annular lip on a top end that forms a seal due to centrifugal force from rotation of the rotor during operation.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a cross section view of an industrial gas turbine engine with first and second stage rotor cooling of the present invention;

FIG. 2 shows a cross section view of a spacer disk in-between the first and second stages of the turbine of the present invention;

FIG. 3 shows an isometric view of the spacer disk of the present invention;

FIG. 4 shows a cross section cutaway of the spacer disk of the present invention with the cooling air supply passages;

FIG. 5 shows a cross section side view of the spacer disk of the present invention with two cooling air inlets and one outlet hole;

FIG. 6 shows a cross section side view of the spacer disk of the present invention with one cooling air inlet and two outlet holes;

FIG. 7 shows a cross section view of the first stage rotor with blades and cooling air supply and discharge holes of the present invention;

FIG. 8 shows a cross section view of the first and second stage rotors and spacer disk and a hot air return manifold and hot air turn down manifold of the present invention;

FIG. 9 shows an isometric view of the spacer disk and the hot air return manifold and hot air turn down manifold with connector tubes of the present invention;

FIG. 10 shows an isometric view of the spacer disk and the hot air return manifold and hot air turn down manifold with connector tubes of FIG. 9 from a different angle;

FIG. 11 shows an exploded view of the spacer disk and the hot air return manifold and hot air turn down manifold with connector tubes of the present invention;

FIG. 12 shows an isometric front and side view of the hot air turn down manifold of the present invention;

FIG. 13 shows an isometric back and side view of the hot air turn down manifold of the present invention;

FIG. 14 shows a side view of the hot air turn down manifold of the present invention;

FIG. 15 shows a top view of the hot air turn down manifold of the present invention;

FIG. 16 shows an isometric front and side view of the hot air return manifold of the present invention;

FIG. 17 shows an isometric back and side view of the hot air return manifold of the present invention;

FIG. 18 shows a side view of the hot air return manifold of the present invention;

FIG. 19 shows a top view of the hot air return manifold of the present invention;

FIG. 20 shows an isometric view of a vertical hot air transfer tube of the present invention;

FIG. 21 shows an isometric view of a horizontal hot air cross-over tube of the present invention;

FIG. 22 shows an isometric view of a horizontal cooling air supply or exhaust tube of the present invention;

FIG. 23 shows a cross section view of the hot cooling air return circuit from the turndown manifold to the combustor inlet of the present invention;

FIG. 24 shows a cross section view of the cooling air delivery to a central passage within the rotor of the turbine rotor cooling circuit of the present invention;

FIG. 25 shows a cross section view of a forward section of the central passage through the rotor of the turbine rotor cooling circuit of the present invention;

FIG. 26 shows a cross section view of an aft section of the central passage through the rotor of the turbine rotor cooling circuit of the present invention;

FIG. 27 shows a cross section view of a paddled minidisk instead of a spacer disk of a second embodiment of the present invention; and

FIG. 28 shows a cross section view of the paddled minidisk of FIG. 27 with cooling air delivered through an axial hole in the second stage rotor of the present invention.

### DETAILED DESCRIPTION

The present invention is an industrial gas turbine engine with a first and second stage rotor cooling circuit that channels spent rotor disk cooling air back into the combustor to be burned with fuel and compressed air from a compressor of the engine. The rotor disk cooling air flows through a central passage formed within a rotor and then up through a spacer disk where the cooling air is split into two paths, with one path going to the first stage rotor disk and the second path going to the second stage rotor disk. Spent rotor blade cooling air flows into a hot air collector manifold located in-between the two rotor disk stages, and then through cross-over tubes in the first stage rotor, and then into a hot air turn-down manifold where the hot spent cooling air then flows in an axial forward direction through the rotor, then through radial holes upward into a static cavity between the compressor and the turbine. The hot spent cooling air then flows through a turn channel and into a diffuser and then into an inlet of the combustor.

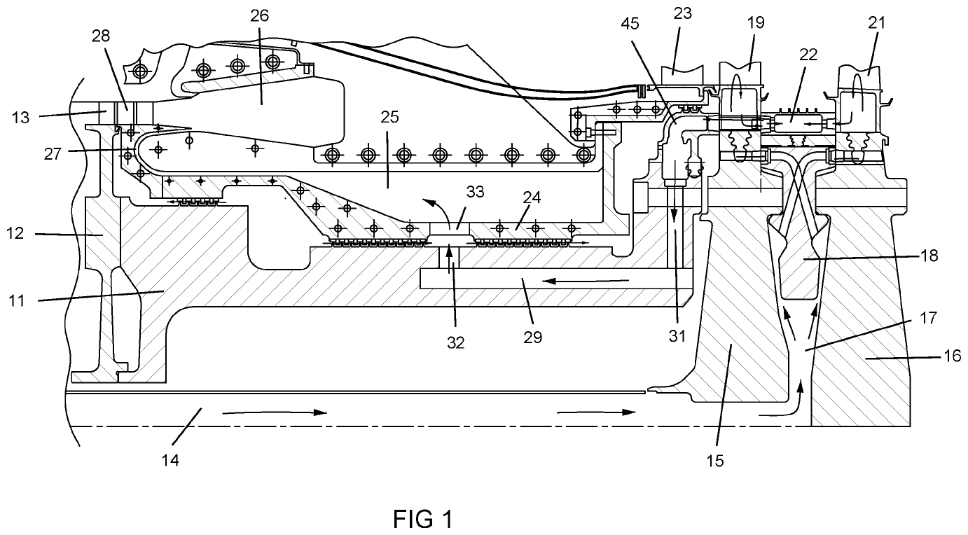

FIG. 1 shows a cross section view of the first and second rotor stage cooling circuit from a central passage supply into and out of the rotor stages, and then back through the rotor and into the combustor. This part of the engine includes a rotor 11, a rotor 12 and compressor blade 13 of a last stage compressor, a axial extending central passage or over pressurized cooling air delivery tube 14 secured within the rotor 11, a first stage rotor disk 15 with a number of first stage rotor blades 19, a second stage rotor disk 16 with a number of second stage rotor blades 21, a space 17 formed between the first and second rotor disks 15 and 16, respectively, for cooling air to enter, a spacer disk 18 (which may also be referred to as a cooling air distribution device) secured between the first and second stage rotor disks 15 and 16, a hot air collector manifold 22 extending from a top of the spacer disk 18, a first stage stator vane 23, a hot air turn-down manifold 45, a radial inward flowing hot air channel 31, an axial forward flowing hot air channel 29, a plurality of rotor discharge holes 32, a plurality of stator cavity inlet or dump holes 33, a stator cavity 25, a hot air turn channel 27, a diffuser 26 that discharges into a combustor inlet, and an inlet guide vane 28. Two labyrinth seals are used to seal both sides of each of the rotor discharge holes 32 and the stator cavity inlet or dump holes 33.

The cooling air delivery tube 14 is an over-pressurized cooling air delivery tube passing through the rotor of the engine that delivers over-pressurized air so that the spent cooling air from the turbine rotor stages will have enough remaining pressure to flow into the combustor of the engine. The over-pressurized cooling air delivery tube 14 also insulates the over-pressurized cooling air from hot sections of the compressor to limit heat transfer to the cooling air flowing through the cooling air delivery tube 14. The compressor outlet discharges compressed air as P3 compressed air. In the embodiment of the present invention analyses, the overpressure would be about 50% greater than the discharge pressure of the compressor outlet that is delivered to the combustor. A supply pressure of 1.35×P3 would have enough pressure to flow through the rotor and turbine stages of blades (through the internal cooling air circuit of each blade 19, 21) and return to the combustor inlet with enough pressure (at around 1.05 of P3) to flow in to the combustor.

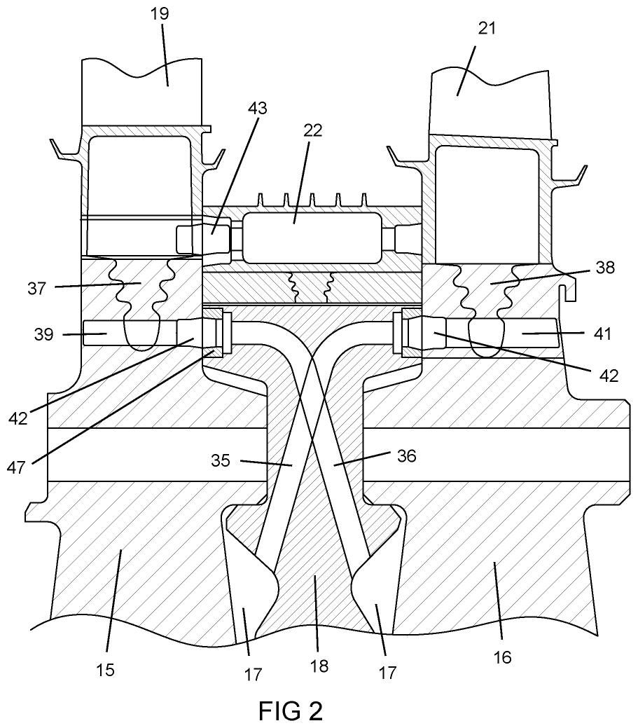

FIG. 2 shows the spacer disk 18 in position between the first stage rotor disk and the second stage rotor disk 16. The spacer disk 18 has an arrangement of first stage cooling air supply passages 36 alternating with second stage cooling air supply passages 35 that each open into the space between the two rotor stages to supply cooling air to the first and second stages of rotor blades 19 and 21. The spacer disk 18 rotates along with the two rotor stages. Inlet tubes 42 connect each outlet end of the first stage cooling air supply passage 36 or the second stage cooling air supply passage 35 to fir tree shaped slots in the rims of the rotor disks 15 and 16 in which the rotor blades are inserted to channel cooling air to each blade cooling circuit (thus, the inlet tubes 42 may also be referred to as connector tubes). Each of the first and second stages of rotor blades 19 and 20 has a fir tree shaped attachment 37 and 38 with a cooling air supply and exhaust passage. Each blade 19 and 21 also has an internal cooling circuit to provide cooling for the blade without discharging any cooling air to the hot gas flow passing through the turbine, each internal cooling circuit having an inlet and an outlet. Spent cooling air from the blades flows through exhaust tubes 43 that connect cooling air outlet from the blades into a common collector manifold 22 (the exhaust tubes 43 may also be referred to as connector tubes). The hot air collector manifold 22 is formed of a number of segments that form a complete annular arrangement of hot air collector manifolds with each segment sealed from adjacent segments. The collector manifold 22 has a row of labyrinth seal forming teeth on a top side that forms a seal between an underside of a stator vane assembly located between the two stages of rotor blades 19 and 21.

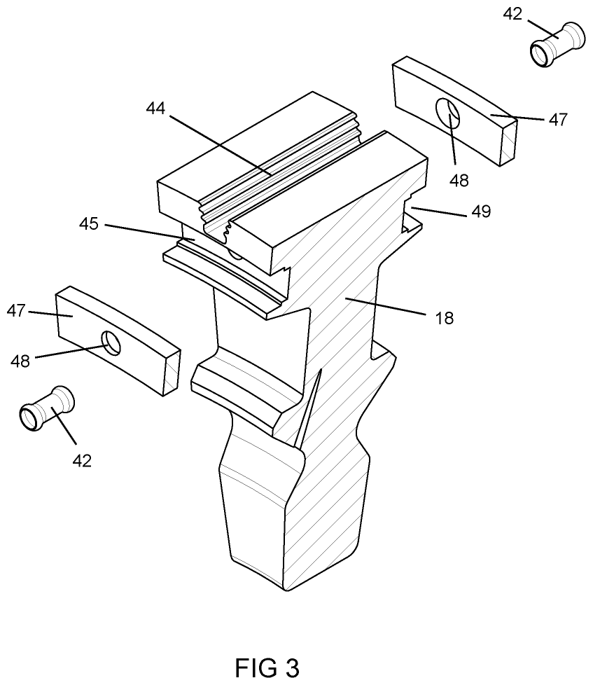

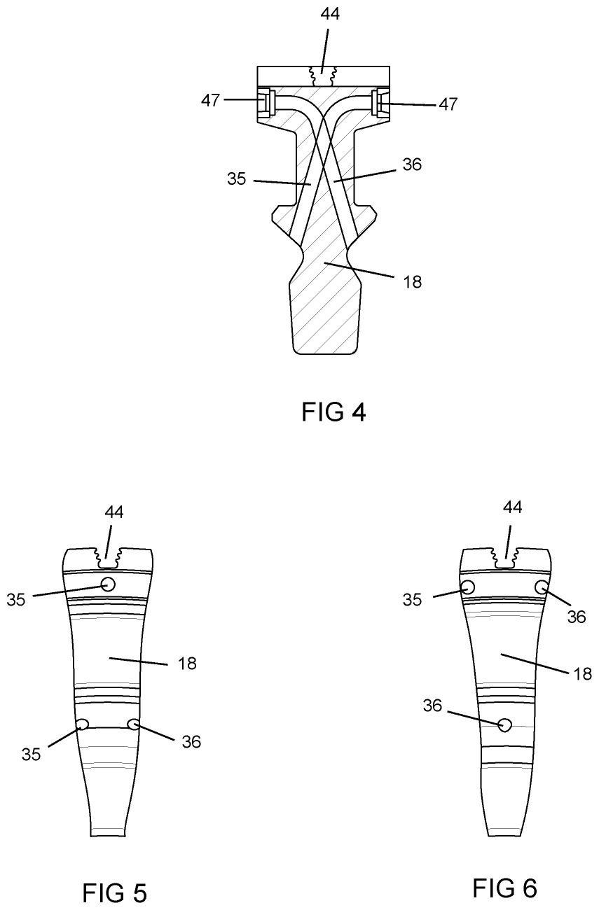

FIG. 3 shows more details of the spacer disk 18 with a turn-down manifold 45 enclosed by an forward annular plate 47 and an aft supply manifold 49 enclosed by an aft annular plate 47. The first and second stage cooling air supply passages 36 and 35 in the spacer disk open into the space covered by the annular plates 47. Each of the first stage cooling air supply passages 36 has an inlet opening into the space 17 and an outlet opening connected to a cooling air inlet opening on the first stage turbine rotor disk 15 and each of the second stage cooling air supply passages 35 has an inlet opening into the space 17 and an outlet opening connected to a cooling air inlet opening on the second stage turbine rotor disk 16. Cooling air passes through the supply holes 48 formed in the annular plates 47. The inlet tubes 42 are pinched between the supply holes 48 and the axial slots 39 and 41 in the rotors to seal the cooling air flow. A fir tree shaped slot 44 in the top side of the spacer disk 18 secures the collector manifold 22 to the spacer disk 18. A cross section front view of the spacer disk 18 with first and second stage cooling air supply passages 36 and 35 is shown in FIG. 4. FIGS. 5 and 6 show a cross section side view of the spacer disk 18, showing the two cooling air supply passages 35 and 36 with the inlet ends and outlet ends of each alternating around the spacer disk 18 (for example, two inlet ends and one outlet end are shown in FIG. 5, whereas one inlet end and two outlet ends are shown in FIG. 6). The spacer disk 18 and any hardware such as the annular plate 47 and the inlet tubes 42 form a between the rotor disks 15 and 16 cooling air supply apparatus. Inlets of the first stage turbine rotor blade cooling air supply passages 36 are located on an aft side of the spacer disk 18 and outlets of the first stage turbine rotor blade cooling air supply passages 36 are located on a forward side of the spacer disk 18. Likewise, inlets of the second stage turbine rotor blade cooling air supply passages 35 are located on a forward side of the spacer disk 18 and outlets of the second stage turbine rotor blade cooling air supply passages 35 are located on an aft side of the spacer disk 18.

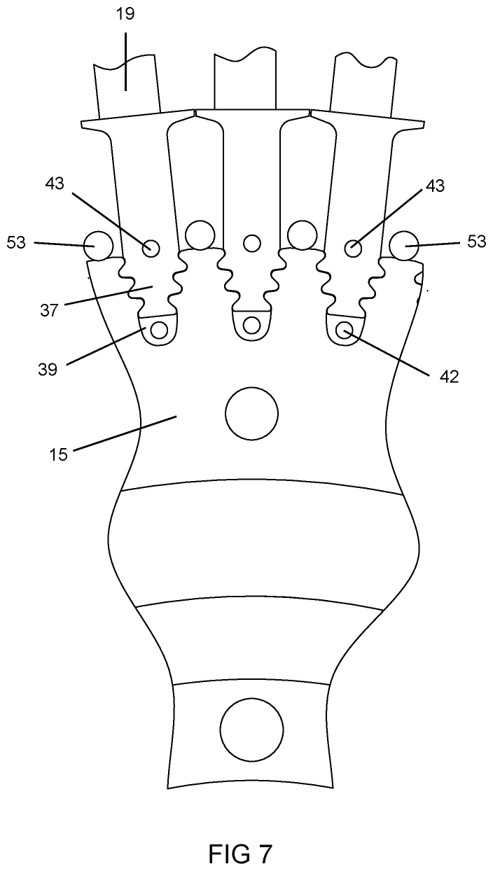

FIG. 7 shows a front view of the first stage rotor disk 15 with axial slots 39 for the blades 19 with the inlet tubes 42 at a bottom of each axial slot 39, an exhaust tube 43 in the blade root near to the rim surface, and cross-over tube 53 that pass from an aft side of the rotor disk 15 to the forward side of the rotor disk 15.

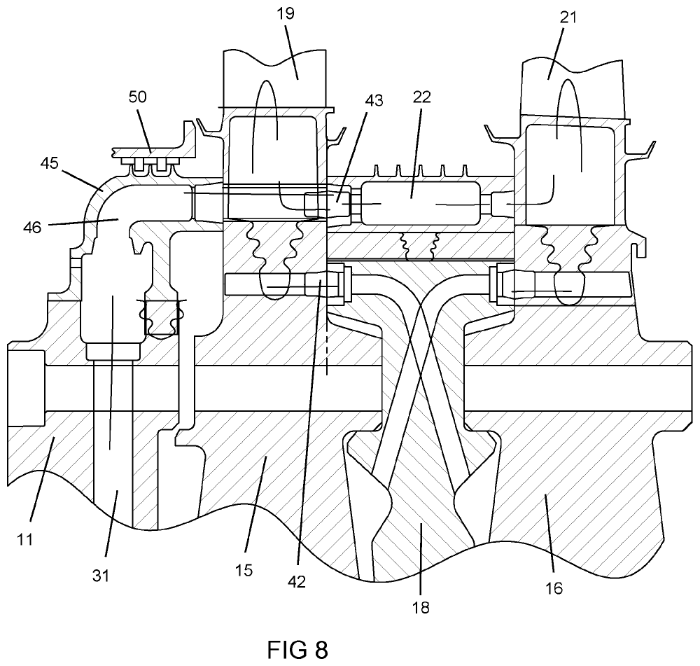

FIG. 8 shows the inlet tubes 42 connected between the outlets of the passages in the spacer disk 18, the exhaust tubes 43 connected between the blade discharge holes and the inlet to the collector manifold 22, and cross-over tubes 53 positioned between adjacent exhaust tubes 43 that connect the collector manifold 22 to a hot air turn-down manifold 45 which turns the hot air flow from forward axial flow to radial inward flow in the turn-down manifold passage 46. Thus, the hot air turn-down manifold 45 is on a forward side of the first stage turbine rotor disk 15. Labyrinth seal 50 seals the stator surface with the rotating surface of the turn-down manifold 45 which has a series of labyrinth sealing teeth extending from a top surface.

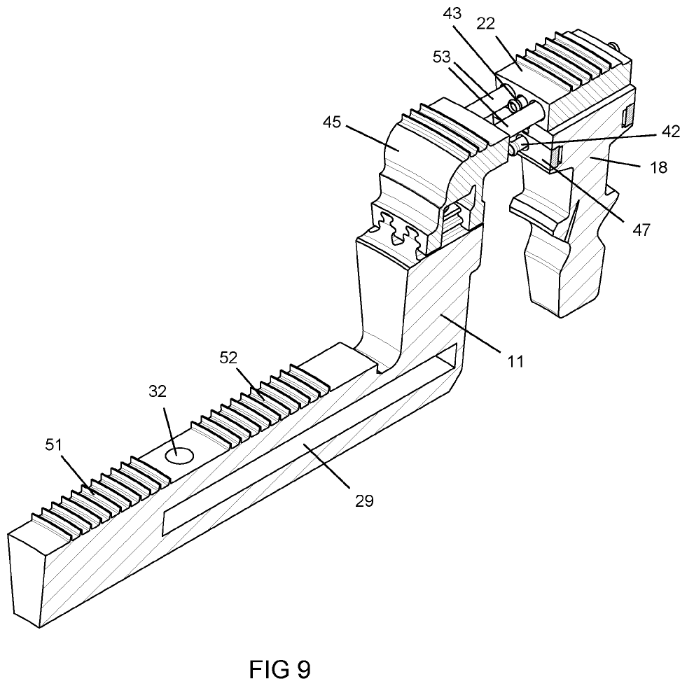

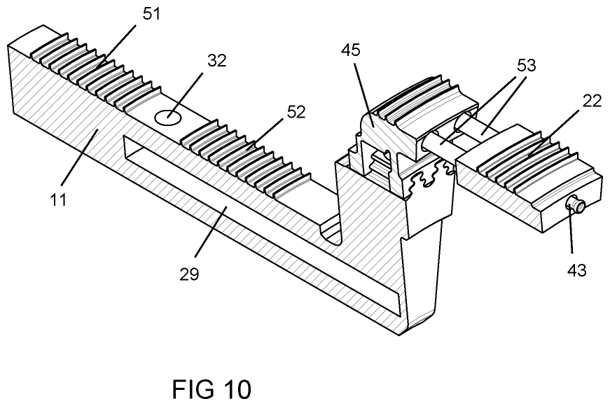

FIG. 9 shows a view of the spacer disk 18, collector manifold 22, turn-down manifold 45, inlet tubes 42, and exhaust tubes 43. The turn-down manifold passage 46 channels the hot cooling air into the radial inward flowing hot air channel 31 that then flows into the axial forward flowing hot air channels 29 within the rotor 11. Rotor discharge holes 32 connect the axial forward flowing hot air channels 29 to stationary dump holes 33 formed in a stator 24 part of the engine. The radial inward flowing hot air channel 31 and the axial forward flowing hot air channel 29 may together be considered a rotor hot air return passage with an inlet connected to the hot air turn-down manifold 45 and an outlet being a rotor discharge hole 32. FIG. 10 shows a front view of the assembly of FIG. 9 with the exhaust tube 43 and the cross-over tubes 53. A forward labyrinth seal 51 and an aft labyrinth seal 52 are formed on both sides of the rotor discharge holes 32 to seal the rotor 11 from the stator 24 around these holes 32 (that is, the forward labyrinth seal 51 is formed on a first side of the rotor discharge hole 32 and stator inlet hole 33 and the aft labyrinth seal 52 is formed on the second side of the rotor discharge hole 32 and the stator inlet hole 33).

FIG. 11 shows an exploded view of the parts of FIGS. 9 and 10 with the spacer disk 18 having a fir tree shaped slot 44, the hot air collector manifold 22 with a fir tree shaped attachment 55 that slides into the fir tree shaped slot 44 of the spacer disk 18, the turn-down manifold 45, the rotor 11 with the radial inward and axial forward flowing hot air channels 29, the exhaust tubes 43, and cross-over tubes 53. The fir tree shaped attachment 55 extends in an axial direction of the industrial gas turbine engine. The rotor 11 has two fir tree shaped attachments and the turn-down manifold 45 has two corresponding fir tree shaped slots 57 to secure the turn-down manifold 45 to the rotor 11 since both are rotating. A radial hot air transfer tube 61 connects the turn-down manifold passage 46 to the rotor radial inward flowing hot air channel 31 in a sealed manner.

Both the collector manifold 22 and the turn-down manifold 45 are formed as segments to form a full annular manifold around the engine, and both are secured to the rotor using fir tree shaped attachments because of the high centrifugal forces developed as the engine rotates.

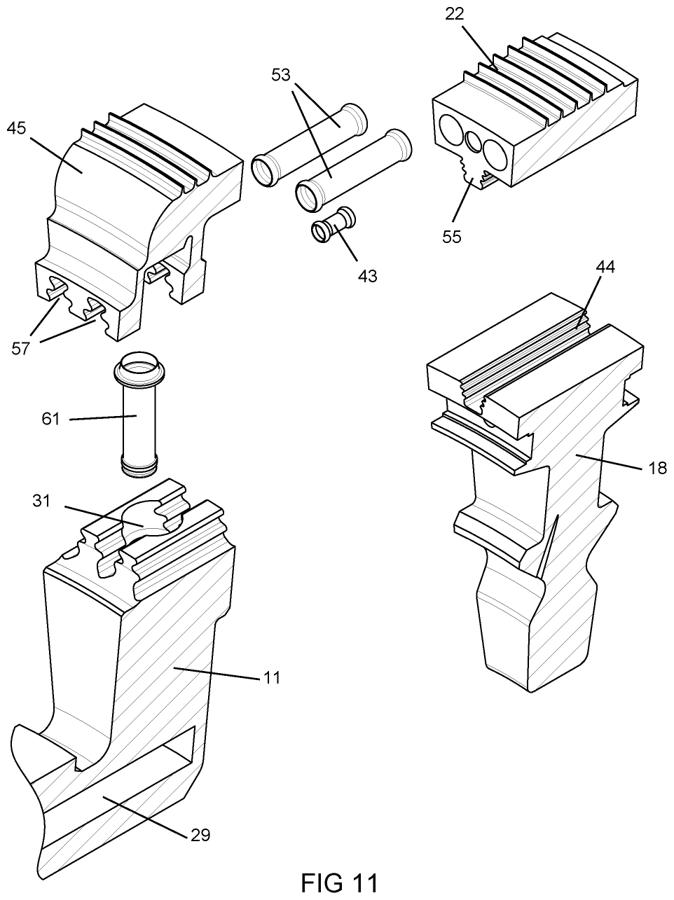

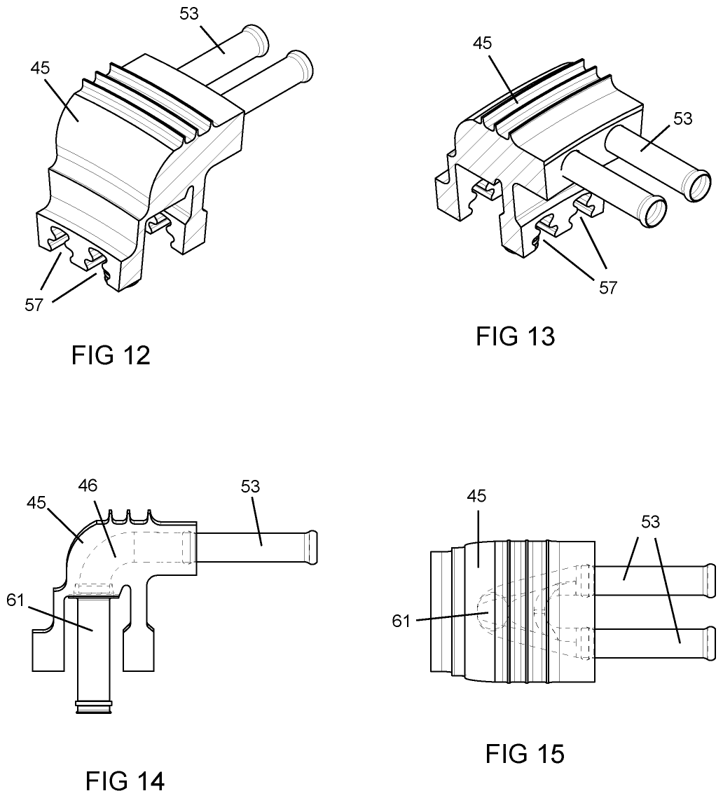

FIG. 12 shows one view of the turn-down manifold 45 with two cross-over tubes 53 and two fir tree shaped slots 57. FIG. 13 shows another view. FIG. 14 shows a side view of the turn-down manifold passage 46 that channels the hot air flow from the cross-over tubes 53. FIG. 15 shows a top view in which two cross-over tubes 53 discharge into the turn-down manifold 45 and merge into one radial inward passage that flows through one of the radial hot air transfer tubes 61. The radial hot air transfer tube 61 has a lip adjacent to the top end that forms a seal with the turn-down manifold passage 46 and is held in place by centrifugal force due to rotation of the rotor.

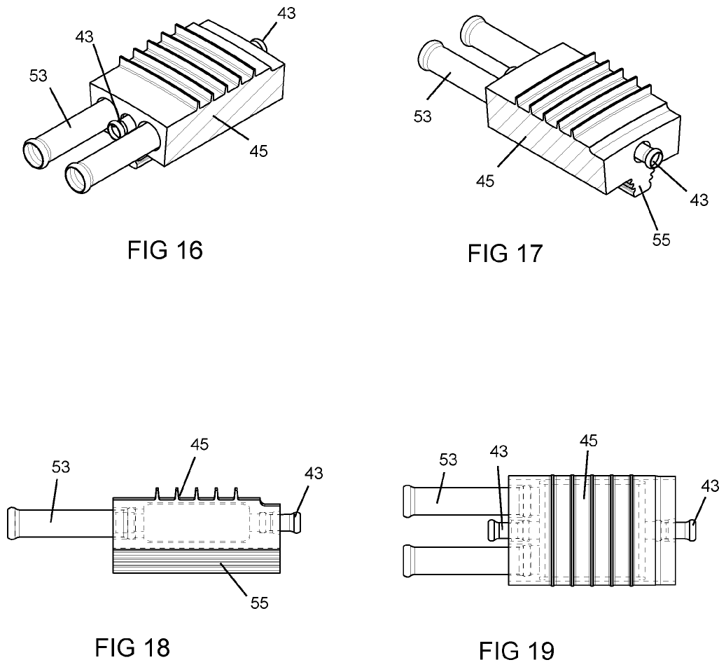

FIG. 16 shows a view of the collector manifold 22 with two hot air exhaust tubes 43 from the adjacent rotor blades (or two collector manifold inlet tubes 43) and two cross-over tubes 53 on the first stage rotor side. Hot air from the two stages of rotor blades flows into the hot air collector manifold segments from both sides, and then flows out from a forward side through two parallel cross-over tubes 53 (which also may be referred to as a first and second collector manifold outlet tubes 53) and into the turn-down manifold 45. A first of the two parallel cross-over tubes 53 may be on a first side of the exhaust tube 43 and a second of the two parallel cross-over tubes 53 may be on a second side of the exhaust tube 43. Further, the collector manifold 22 may include a plurality of annular segments that together form a full annular collector manifold. FIG. 17 shows an aft side of the collector manifold 22 with the single hot air exhaust tube 43 from one of the second stage rotor blades 21. FIG. 18 shows a side view with the cavity within the collector manifold 22, the exhaust tube 43, and the cross-over tube 53. FIG. 19 shows a top view with an exhaust tube 43 on each of the two sides of the collector manifold 22, and two cross-over tubes 53 on the forward side of the collector manifold 22.

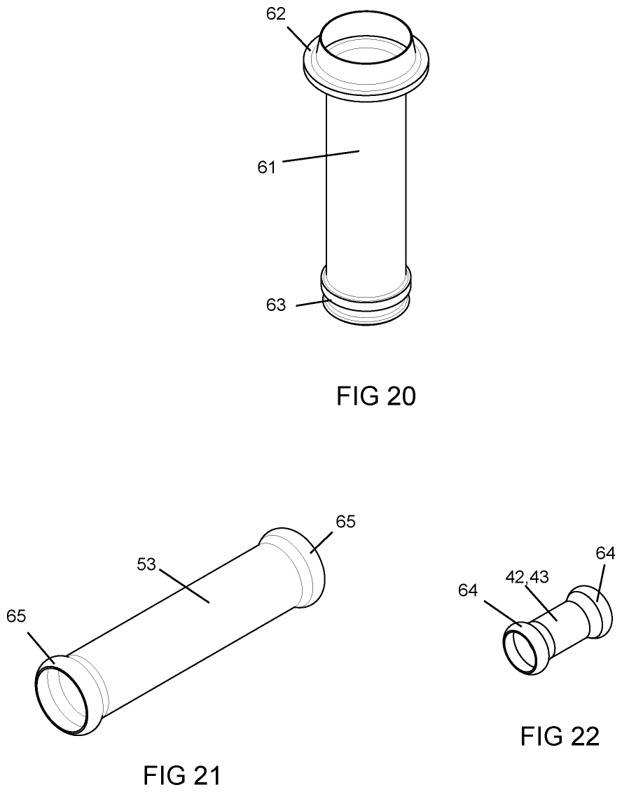

FIG. 20 shows the radial hot air transfer tube 61 with the first annular lip 62 that seals the tube in the hot air passage of the turn-down manifold. The radial hot air transfer tube 61 also has a second annular lip 63 opposite the first annular lip 62. Rotation of the rotor forces the radial hot air transfer tube 61 upward against the bottom surface of the radial inward passage to form a tight seal. FIG. 21 shows a cross-over tube 53 with dog-bone shaped ends 65 that form a tight seal when the tube is squeezed between the turn-down manifold 45 and the collector manifold 22. As shown in FIG. 22, the inlet and exhaust tubes 42 and 43 are of the same shape and size and are also dog-bone shaped ends 64 that are squeezed between two sides to form a tight seal for the cooling air flowing through the tubes. However, the cross-over tube 53 may have a diameter that is larger than the diameter of the exhaust tube 43.

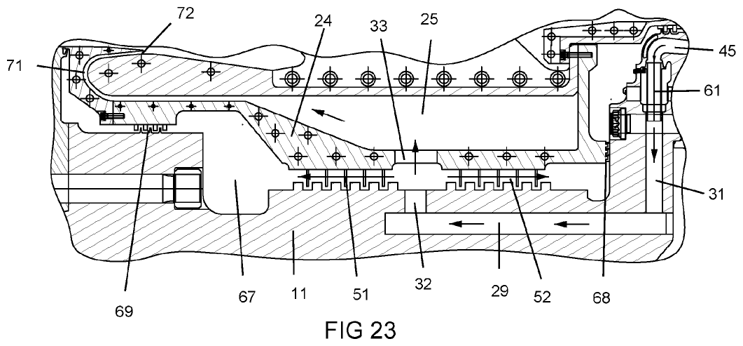

FIG. 23 shows the stator hot air return passageway from the turn-down manifold 45 to an inlet 72 of the diffuser 26. The hot air flows through the radial hot air transfer tubes 61 to the radial inward flowing hot air channel 31, turns 90 degrees and flows forward in the axial forward flowing hot air channels 29 of the rotor 11, turns 90 degrees and flows through the rotor discharge holes 32 and into the static dump holes 33 and into the static cavity 25 of the stator 24. The hot air from the stator cavity 25 then flows through a channel and turns around 180 degrees and flows aftward into the inlet 72 of the diffuser 26 at the discharge end of the passages. The stator hot air return passage connects the stator cavity 25 with an inlet of the combustor. A forward labyrinth seal 51 and an aft labyrinth seal 52 forms a seal between the rotor 11 and the stator 24 around the rotating rotor discharge holes 32 and the static dump holes 33. Another seal 69 (such as a labyrinth seal) is used around the 180 degree turns, and other seals (such as labyrinth seals) are used and near the radial inward flowing hot air channels 31 to seal between the rotor and the stator.

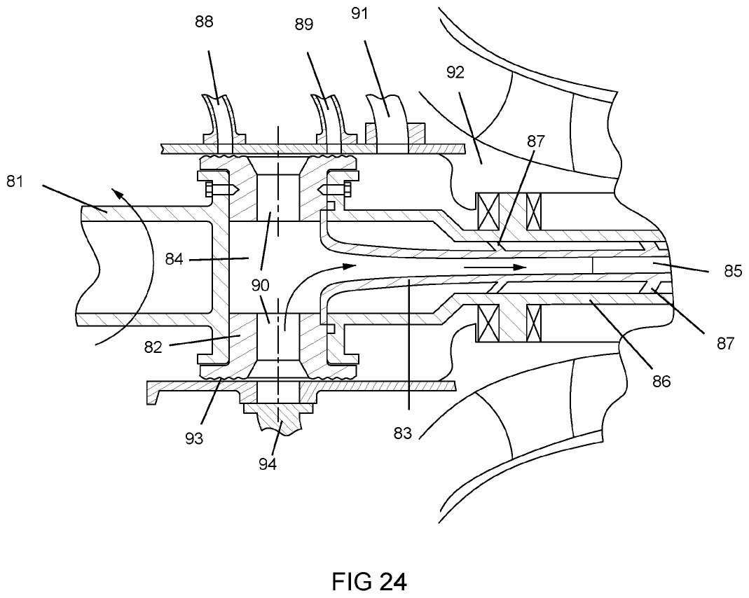

FIG. 24 shows the cooling air supply circuit for delivery outside cooling air to the rotor. A delivery pipe 94 connects a source to a high pressure compressor inlet casing and into a number of radial inlet holes 90 formed in compressor rotor shaft end piece 82 that forms a rotor cavity 84 for a supply of cooling air. A central delivery pipe 83 is secured to the compressor rotor shaft end piece 82 by clamping flanged ends between the compressor rotor shaft end piece 82 and a compressor rotor 86. The central delivery pipe 83 forms a central passage 85 for the cooling air to flow to the turbine section and moves the relatively cool cooling air away from the hot sections of the compressor. A generator drive shaft 81 is connected to the compressor rotor shaft end piece 82 and is connected to an electric generator. Bleed pipes 88, 89, and 91 draw off air leaking from around seals 93 formed between the rotating compressor rotor shaft end piece 82 and the static casing. Radial centering features 87 extend from the delivery pipe 83 and function to center the central passage 85 within the compressor rotor 86. A bearing compartment 92 is located outside of the compressor rotor 86. Compressed cooling air from a source flows into the rotor cavity 84 through the radial inlet holes 90 and turns into the central passage 85 to flow toward the turbine.

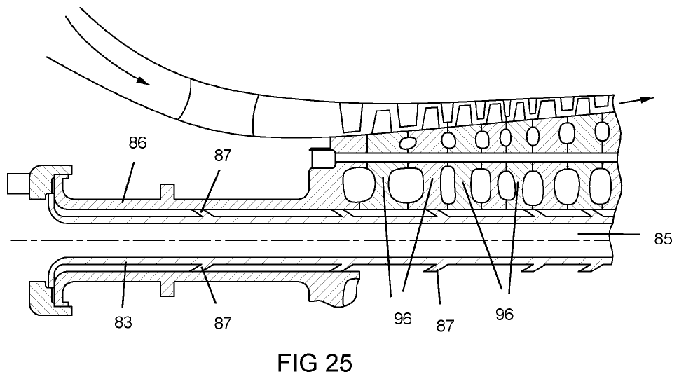

FIG. 25 shows the cooling air central passage 85 within the compressor rotor 86 with the radial centering features 87. Rotor disks 96 are stacked together to form the compressor rotor with the compressed air flow path through stages of stator vanes and rotor blades extending from the compressor rotor 86. The central delivery pipe 83 passes through the compressor rotor 86 and insulates the cooling air from heat generated in the compressor so as to minimize heating of the cooling air.

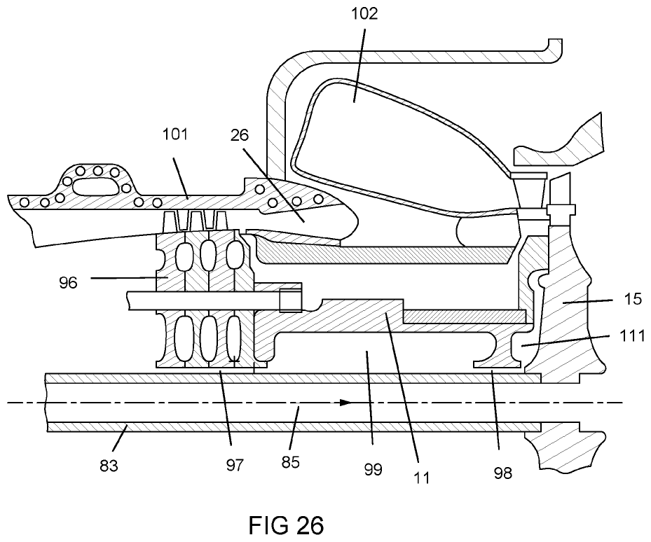

FIG. 26 shows the central passage 85 of the delivery pipe 83 that ends adjacent to the first rotor disk 15. Centering standoffs 97 and 98 are used to center the delivery pipe 83 within the engine rotor 11. An intermediate pressure cavity 111 is formed between the rotor 11 and the first stage rotor disk 15. FIG. 26 also shows an intermediate pressure cavity 99, the compressor casing 101, and the combustor 102 of the engine. The diffuser 26 is also shown in which the hot air from the turbine rotors used to cool the rotor blades is discharged.

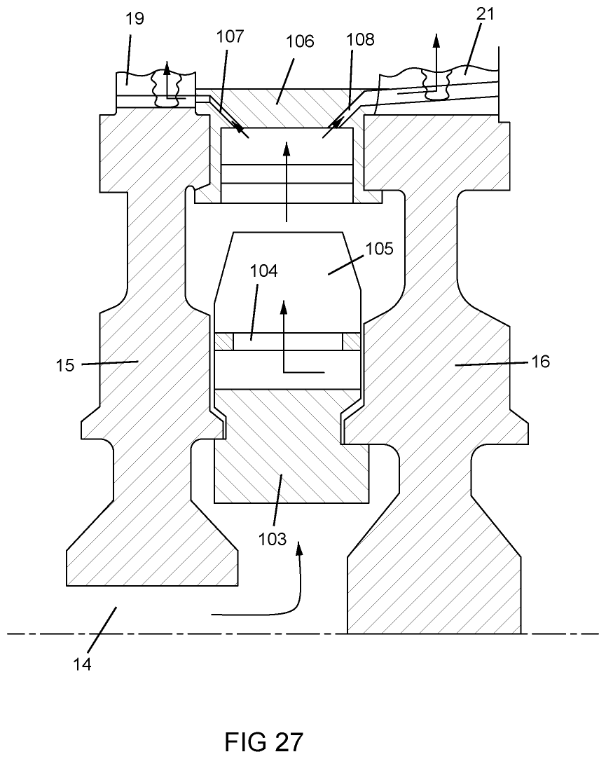

FIG. 27 shows another embodiment of the present invention in which a paddled mini disk is used to force cooling air up and into the first and second stage rotors for cooling of the blades. The mini disk 103 has a number of radial holes 104 for cooling air flow leading into spaces formed between adjacent paddles 105 that extend outward from the mini disk 103. The paddled mini disk 103 rotates with the two rotor disks 15 and 16 to force the cooling air up into a feed cavity in an annular segmented cap 106 that encloses the space between the two rotor disks 15 and 16. The annular segmented cap 106 would have the collector manifold 22 connected to the top surface. The air supply holes 107 and 108 deliver the cooling air from the mini disk 103 to the two stages of rotor blades 19 and 21. Inlet and discharge tubes would still be used to connect the cooling air passages into the first and second stage rotors.

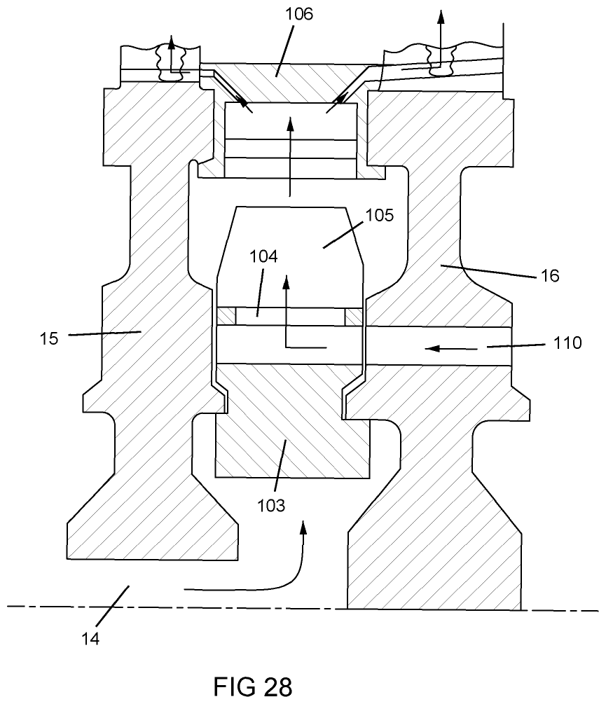

FIG. 28 shows another version of the FIG. 27 embodiment of the paddled mini disk but with the cooling air supplied from axial holes 110 in the second stage rotor disk 16. Although shown in FIG. 28, no cooling air delivery tube 14 for the cooling air would then be needed. If the cooling air delivery tube 14 is included, no cooling air will be directed through the cooling air delivery tube 14 in this embodiment. The paddled mini disk 103 and any hardware such as the annular segmented cap 106 and the air supply holes 107 and 108 form a between the rotor disks 15 and 16 cooling air supply apparatus.

Further features of the invention are disclosed in the numbered Embodiments set forth below.

### Embodiment 1

An industrial gas turbine engine for electric power production comprising: a compressor connected by a rotor to a turbine; a first stage turbine rotor with a first stage turbine blade; the first stage turbine blade having an internal cooling air circuit; a second stage turbine rotor with a second stage turbine blade; the second stage turbine blade having an internal cooling air circuit; a cooling air distribution device positioned between the first stage turbine rotor and the second stage turbine rotor; the cooling air distribution device having a first stage turbine blade cooling air supply passage and a second stage turbine blade cooling air supply passage; a hot air collection manifold extending from the cooling air distribution device and positioned between the first stage turbine rotor and the second stage turbine rotor; a hot air turn-down manifold positioned on a forward side of the first stage turbine rotor; a rotor hot air return passage with an inlet connected to the hot air turn-down manifold and an outlet being a rotor discharge hole; a stator with an inlet hole opening into a stator cavity and aligned with the rotor discharge hole; a stator hot air return passage connecting the stator cavity with an inlet of a combustor; and, a central delivery tube located within the rotor to delivery compressed air to the spacer disk through the first stage turbine rotor.

### Embodiment 2

The industrial gas turbine engine for electric power production of Embodiment 1, and further comprising: the cooling air distribution device comprises a spacer disk with alternating first stage and second stage cooling air supply passages each having an inlet opening into a cavity formed between the first stage turbine rotor and the second stage turbine rotor and outlets connected to cooling air inlet openings on the first and second stage turbine rotor disks.

### Embodiment 3

The industrial gas turbine engine for electric power production of Embodiment 1, and further comprising: a first labyrinth seal and a second labyrinth seal formed between the rotor and the stator on both sides of the rotor discharge hole and the stator inlet hole.

### Embodiment 4

The industrial gas turbine engine for electric power production of Embodiment 1, and further comprising: a space formed between the first stage turbine rotor and the second stage turbine rotor connected to the central delivery tube to supply cooling air to the spacer disk cooling air supply passages.

### Embodiment 5

The industrial gas turbine engine for electric power production of Embodiment 1, and further comprising: the hot air collection manifold is connected to the hot air turn-down manifold through a cross-over tube passing through the first stage turbine rotor.

### Embodiment 6

The industrial gas turbine engine for electric power production of Embodiment 1, and further comprising: the hot air collection manifold includes a first stage turbine blade hot air inlet on a forward side and a second stage turbine blade hot air inlet on an aft side; and, the hot air collection manifold includes a hot air outlet on a forward side.

### Embodiment 7

The industrial gas turbine engine for electric power production of Embodiment 1, and further comprising: the hot air turn-down manifold includes first and second hot air axial inlets on an aft side and a single hot air radial inward outlet with a 90 degree turn channel in-between.

### Embodiment 8

The industrial gas turbine engine for electric power production of Embodiment 1, and further comprising: a transfer tube connected between an outlet of the hot air turn-down manifold and an inlet of the hot air return passage of the rotor to form a seal due to rotation of the rotor.

### Embodiment 9

A process for operating an industrial gas turbine engine with a cooling circuit for a first and second stages of turbine rotor blades comprising the steps of: passing over-pressurized cooling air through a central passage located within a rotor of the engine; separating the over-pressurized cooling air into a first stage cooling air flow and a second stage cooling air flow; passing the first stage cooling air flow through a cooling circuit formed within the first stage of turbine rotor blades; passing the second stage cooling air flow through a cooling circuit formed within the second stage of turbine rotor blades; collecting the cooling air flow from the first stage turbine rotor blades and the second stage turbine rotor blades in a common collection manifold; passing the cooling air from the common collection manifold through the first stage turbine rotor disk; passing the cooling air from the first stage turbine rotor disk through the rotor of the engine; discharging the cooling air from the rotor of the engine into a cooling air cavity formed in a stator of the engine; and, passing the cooling air from the stator cavity into a combustor of the engine.

### Embodiment 10

A process for operating an industrial gas turbine engine with a cooling circuit for a stage of turbine rotor blade of Embodiment 9, and further comprising the step of: passing the over-pressurized cooling air into the central passage located within the rotor with enough pressure to cool the turbine rotor blade and flow into the combustor.

### Embodiment 11

A process for operating an industrial gas turbine engine with a cooling circuit for a stage of turbine rotor blade of Embodiment 9, and further comprising the step of: passing the over-pressurized cooling air through a spacer disk positioned between a first stage rotor of the turbine and a second stage rotor of the turbine prior to passing the cooling air into the cooling circuit formed within the turbine rotor blade.

### Embodiment 12

A process for operating an industrial gas turbine engine with a cooling circuit for a stage of turbine rotor blade of Embodiment 9, and further comprising the steps of: passing the cooling air from the collection manifold through the first stage turbine rotor into a turn-down manifold located on a forward side of the first stage turbine rotor; and, passing the cooling air from the turn-down manifold into the cooling air passage in the rotor.

### Embodiment 13

A cooling air distribution assembly for supply and discharge of cooling air to first and second stage rotor blades of an industrial gas turbine engine comprising: a spacer disk with a plurality of first stage turbine rotor blade cooling air supply passages alternating with a plurality of second stage turbine rotor blade cooling air supply passages; inlets of the first stage turbine rotor blade cooling air supply passages are located on an aft side of the spacer disk; inlets of the second stage turbine rotor blade cooling air supply passages are located on a forward side of the spacer disk; outlets of the first stage turbine rotor blade cooling air supply passages are located on a forward side of the spacer disk; outlets of the second stage turbine rotor blade cooling air supply passages are located on an aft side of the spacer disk; a cooling air collection manifold is secured to a top side of the spacer disk; the cooling air collection manifold having a first cooling air inlet on a forward side of the collection manifold; the cooling air collection manifold having a second cooling air inlet on an aft side of the collection manifold; the cooling air collection manifold having a first and a second of cooling air outlet on the forward side of the collection cavity and on both sides of the first cooling air inlet.

### Embodiment 14

The cooling air distribution assembly for supply and discharge of cooling air to first and second stage rotor blades of an industrial gas turbine engine of Embodiment 13, and further comprising: the cooling air collection manifold is a plurality of annular segments that form a full annular collection manifold.

### Embodiment 15

The cooling air distribution assembly for supply and discharge of cooling air to first and second stage rotor blades of an industrial gas turbine engine of Embodiment 13, and further comprising: the collection manifold is secured to the spacer disk with a fir tree shaped attachment.

### Embodiment 16

The cooling air distribution assembly for supply and discharge of cooling air to first and second stage rotor blades of an industrial gas turbine engine of Embodiment 15, and further comprising: the fir tree shaped attachment extends in an axial direction of the industrial gas turbine engine.

### Embodiment 17

The cooling air distribution assembly for supply and discharge of cooling air to first and second stage rotor blades of an industrial gas turbine engine of Embodiment 13, and further comprising: the first and second cooling air inlets are each connected to a sealed hollow exhaust tube; and, the first and second cooling air outlets are each connected to a sealed hollow cross-over tube.

### Embodiment 18

The cooling air distribution assembly for supply and discharge of cooling air to first and second stage rotor blades of an industrial gas turbine engine of Embodiment 17, and further comprising: the cross-over tube has a larger diameter than the exhaust tube.

### Embodiment 19

The cooling air distribution assembly for supply and discharge of cooling air to first and second stage rotor blades of an industrial gas turbine engine of Embodiment 17, and further comprising: the exhaust tube and the cross-over tube are both dog-bone shaped tubes.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A gas turbine engine comprising:
a compressor connected by a rotor to a turbine;
a first stage turbine rotor disk with a first stage turbine blade;
the first stage turbine blade having an internal cooling air circuit;
a second stage turbine rotor disk with a second stage turbine blade;
the second stage turbine blade having an internal cooling circuit;
a cooling air distribution device positioned between the first stage turbine rotor disk and the second stage turbine rotor disk;
the cooling air distribution device having a first stage turbine blade cooling air supply passage and a second stage turbine blade cooling air supply passage; and
a hot air collection manifold positioned above the cooling air distribution device and between the first stage turbine rotor disk and the second stage turbine rotor disk for collecting cooling air from the first and second stage blades.

2. The gas turbine engine of claim 1, wherein the cooling air distribution device comprises a spacer disk with alternating first stage and second stage cooling air supply passages each having an inlet opening into a space formed between the first stage turbine rotor disk and the second stage turbine rotor disk and an outlet opening connected to cooling air inlet openings on the first and second stage turbine rotor disks.

3. The gas turbine engine of claim 1, further comprising:
a first labyrinth seal and a second labyrinth seal formed between the rotor and the stator, the first labyrinth seal being on a first side of the rotor discharge hole and the stator inlet hole and the second labyrinth seal being on a second side of the rotor discharge hole and the stator inlet hole.

4. The gas turbine engine of claim 1, wherein the space formed between the first stage turbine rotor disk and the second stage turbine rotor disk is connected to the central delivery pipe to supply cooling air to the cooling air distribution device cooling air supply passages.

5. The gas turbine engine of claim 20, wherein the hot air collection manifold is connected to the hot air turn-down manifold through a cross-over tube passing through the first stage turbine rotor disk.

6. The gas turbine engine of claim 20, wherein the hot air collection manifold includes:
a first stage turbine blade hot air inlet on a forward side;
a second stage turbine blade hot air inlet on an aft side; and
a hot air outlet on a forward side.

7. The gas turbine engine of claim 20, wherein the hot air turn-down manifold includes first and second hot air axial inlets on an aft side and a single hot air radial inward outlet with a 90 degree turn channel in-between.

8. The gas turbine engine of claim 20, and further comprising:
a transfer tube connected between an outlet of the hot air turn-down manifold and an inlet of the hot air return passage of the rotor to form a seal due to rotation of the rotor.

9. A process for operating a gas turbine engine with a cooling circuit for first and second rows of turbine rotor blades comprising the steps of:
passing over-pressurized cooling air through a central passage located within a rotor of the gas turbine engine;
cooling the first and second rows of turbine rotor blades with the over-pressurized cooling air; and
discharging the spent cooling air from the first and second rows of turbine rotor blades into a combustor.

10. A process for operating a gas turbine engine with the cooling circuit for first and second rows of turbine rotor blades of claim 9, and further comprising the step of:
passing the over-pressurized cooling air into the central passage located within the rotor with enough pressure to cool the turbine rotor blades and flow into the combustor.

11. A process for operating a gas turbine engine with the cooling circuit for first and second rows of turbine rotor blades of claim 9, and further comprising the step of:
passing the over-pressurized cooling air through a spacer disk positioned between a first row rotor disk of the turbine and a second row rotor disk of the turbine prior to passing the cooling air into the cooling circuit formed within the turbine rotor blades.

12. A process for operating gas turbine engine with the cooling circuit for first and second rows of turbine rotor blades of claim 9, and further comprising the steps of:
passing the cooling air from the common collector manifold through the first row turbine rotor disk into a turn-down manifold located on a forward side of the first row turbine rotor disk; and
passing the cooling air from the turn-down manifold into the cooling air passage in the rotor.

13. A cooling air distribution assembly for supply and discharge of cooling air to first and second row rotor blades of a gas turbine engine comprising:
a spacer disk with a plurality of first row turbine rotor blade cooling air supply passages alternating with a plurality of second row turbine rotor blade cooling air supply passages;
inlets of the first row turbine rotor blade cooling air supply passages being located on an aft side of the spacer disk;
inlets of the second row turbine rotor blade cooling air supply passages being located on a forward side of the spacer disk;
outlets of the first row turbine rotor blade cooling air supply passages being located on a forward side of the spacer disk;
outlets of the second row turbine rotor blade cooling air supply passages being located on an aft side of the spacer disk;
a cooling air collector manifold positioned above the spacer disk;
the cooling air collector manifold having a first cooling air inlet on a forward side of the collection manifold;
the cooling air collector manifold having a second cooling air inlet on an aft side of the collection manifold; and
the cooling air collector manifold having a cooling air outlet on the forward side of the collection cavity.

14. The cooling air distribution assembly for supply and discharge of cooling air to first and second row rotor blades of a gas turbine engine of claim 13, wherein the collector manifold is a plurality of annular segments that form a full annular collector manifold.

15. The cooling air distribution assembly for supply and discharge of cooling air to first and second row rotor blades of a gas turbine engine of claim 13, wherein the collector manifold is secured to the spacer disk with a fir tree shaped attachment.

16. The cooling air distribution assembly for supply and discharge of cooling air to first and second row rotor blades of a gas turbine engine of claim 15, wherein the fir tree shaped attachment extends in an axial direction of the industrial gas turbine engine.

17. The cooling air distribution assembly for supply and discharge of cooling air to first and second row rotor blades of a gas turbine engine of claim 13, wherein:
the first and second cooling air inlets are each connected to a sealed hollow exhaust tube; and,
the first and second cooling air outlets are each connected to a sealed hollow cross-over tube.

18. The cooling air distribution assembly for supply and discharge of cooling air to first and second row rotor blades of a gas turbine engine of claim 17, wherein the cross-over tube has a larger diameter than the exhaust tube.

19. The cooling air distribution assembly for supply and discharge of cooling air to first and second row rotor blades of a gas turbine engine of claim 17, wherein the exhaust tube and the cross-over tube are both dog-bone shaped tubes.

20. The gas turbine engine claim 1, further comprising:
a hot air turn-down manifold positioned on a forward side of the first stage turbine rotor disk;
a rotor hot air return passage with an inlet connected to the hot air turn-down manifold and an outlet being a rotor discharge hole;
a stator with an inlet opening into a stator cavity and aligned with the rotor discharge hole;
a stator hot air return passage connecting the stator cavity with an inlet of a combustor; and
a central delivery pipe located within the rotor to deliver compressed air to the cooling air distribution device through the first stage turbine rotor disk.

21. A process for operating a gas turbine engine with a cooling circuit for first and second rows of turbine rotor blades of claim 9, and further comprising the step of:
separating the over-pressurized cooling air into a first row cooling air flow and a second row cooling air flow;
passing the first row cooling air flow through a cooling circuit formed within the first row of turbine rotor blades;
passing the second row cooling air flow through a cooling circuit formed within the second row of turbine rotor blades;
collecting the cooling air flow from the first row turbine rotor blades and the second row turbine rotor blades in a common collector manifold;
passing the cooling air from the common collector manifold through the first row turbine rotor disk;
passing the cooling air from the first row turbine rotor disk through the rotor of the industrial gas turbine engine;
discharging the cooling air from the rotor of the industrial gas turbine engine into a cooling air stator cavity formed in a stator of the industrial gas turbine engine; and
passing the cooling air from the stator cavity into a combustor of the industrial gas turbine engine.
